(19) United States
(12) Patent Application Publication
(10) Pub. No.: US 2018/0293669 A1
(43) Pub. Date: Oct. 11, 2018

(54) SYSTEM AND METHOD OF COLLECTING AND PROVIDING SERVICE PROVIDER RECORDS

(71) Applicant: Relola, Inc., Emeryville, CA (US)

(72) Inventors: Heather Sittig Jackson, Oakland, CA (US); Graham Golder, Fremont, CA (US)

(73) Assignee: Relola, Inc., Emeryville, CA (US)

(21) Appl. No.: 15/949,003

(22) Filed: Apr. 9, 2018

Related U.S. Application Data
(60) Provisional application No. 62/483,128, filed on Apr. 7, 2017.

(51) Int. Cl. G06Q 50/00; G06F 17/30

(52) U.S. Cl. CPC G06Q 50/01; G06F 17/30864; G06F 17/30241

(57) ABSTRACT

A method may comprise storing a first service provider record associated with a first project located at a first geographic location, receiving a request for project identifiers located within a section of a geographic area, providing a subset of the first set of the one or more project identifiers to be displayed on a second map the first user device, receiving a selected project of the project identifiers, providing a project page indicating categorical identifiers associated with the first project indicating at least some work performed, a link to at least one service professional's profile page, an opinion review and an insight review, receiving a selection of the link to the at least one service professional's profile page, and providing, a profile page of the at least one service professional, the profile page including contact information of the at least one service professional.

### CROSS-REFERENCE TO RELATED APPLICATIONS

The present application claims benefit of U.S. Provisional Patent Application No. 62/483,128 filed Apr. 7, 2017, and entitled “Reloladex Agents” which is incorporated by reference herein.

### FIELD OF THE INVENTION

Embodiments of the present invention related generally to collecting and providing service provider records associated with projects over a large geographic area for multiple independent systems.

### SUMMARY

An example non-transitory computer readable medium comprising instructions executable by a processor, the instructions being executable to perform a method, the method comprises registering, by a service provider record system, accounts for a plurality of users, authenticating, by the service provider record system, a first user of the plurality of users, receiving a first request to store a first service provider record, the first service provider record by the first user of the plurality of users, the first service provider record being associated with a first project located at a first geographic location, the first request to store service provider record including a first user identifier, one or more first categorical identifiers associated with the first project indicating at least some work performed on the project, and a location identifier associated with the first geographic location, the first project associated with the first service provider record, receiving a request from a first user device for project identifiers located within a section of a geographic area, retrieving a first set of one or more project identifiers based on the request for the project identifiers located within the section of the geographic area, providing the first set of the one or more project identifiers to the first user device, the first set of the one or more project identifiers to be displayed on a first map to the first user device, each particular project identifier of the first set of the one or more project identifiers to be displayed on the first map in a general location where work was performed on the particular project identifier, receiving a request from a first user device for a subset of a first set of project identifiers located within a subsection of the geographic area, retrieving the subset of the first set of project identifiers located within a subsection of the geographic area based on the request for the subset of the first set of project identifiers located within the subsection of the geographic area, providing the subset of the first set of the one or more project identifiers to the first user device, the subset of the first set of the one or more project identifiers to be displayed on a second map the first user device, each particular project identifier of the subset of the first set of the one or more project identifiers to be displayed on the second map in a general location where work was performed on the particular project identifier, receiving, from the first user device, a selected project of the subset of the first set of the one or more project identifiers, the selected project being the first project, providing to the first user device, based at least in part on the first service provider record, a project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project, receiving, from the first user device, a selection of the link to the at least one service professional's profile page associated with the selected project, the at least one service professional having performed work on the selected project, and providing, to the first user device, a profile page of the at least one service professional, the profile page including contact information of the at least one service professional.

The method may further comprise providing the first map and the second map. In some embodiments, the method may further comprise receiving the insight review from the second reviewer, verifying that the second reviewer is a licensed professional, verifying that a license of the licensed professional is associated with the field associated with the at least some work performed on the selected project, and labelling the insight review as being an expert opinion. The method may comprise receiving the opinion review from the first reviewer, verifying that the first reviewer is not a licensed professional, and labelling the opinion review as being a non-expert opinion.

In various embodiments, the profile page of the at least one service professional may include contact information and/or selected service professionals of the at least one service professional. The method may further comprise tracking navigation information of the user from the project page, to the profile page of the at least one service professional, and to a profile page of one of the selected service professionals linked to the profile page, and generating a report indicating at least some of the tracking navigation information to enable origination credit to the at least one service professional.

Retrieving the first set of one or more project identifiers based on the request for the project identifiers located within the section of the geographic area may comprise determining a domain of a web page that provided the request for the project identifiers located within the section of the geographic area and retrieving the first set of one or more project identifiers based, at least in part, on the domain.

In various embodiments, the method may further comprise receiving a request from a second user device for project identifiers located within the section of a geographic area, retrieving a second set of one or more project identifiers based on the request from the second user device for the project identifiers located within the section of the geographic area, providing the second set of the one or more project identifiers to the second user device, the first set of the one or more project identifiers to be displayed on a second map to the second user device, each particular project identifier of the second set of the one or more project identifiers to be displayed on the second map in a general location where work was performed on the particular project identifier, receiving a request from the second user device for a subset of a second set of project identifiers located within the subsection of the geographic area, retrieving the subset of the second set of project identifiers located within the subsection of the geographic area based on the request for the subset of the second set of project identifiers located within the subsection of the geographic area, providing the subset of the second set of the one or more project identifiers to the second user device, the subset of the second set of the one or more project identifiers to be displayed on a fourth map the second user device, each particular project identifier of the subset of the second set of the one or more project identifiers to be displayed on the fourth map in a general location where work was performed on the particular project identifier, receiving, from the second user device, a selected project of the subset of the second set of the one or more project identifiers, the selected project being the first project, providing to the second user device, based at least in part on the first service provider record, the project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project, receiving, from the second user device, a selection of the link to the at least one service professional's profile page associated with the selected project, the at least one service professional having performed work on the selected project, and providing, to the second user device, a profile page of the at least one service professional, the profile page including contact information of the at least one service professional.

A system may comprise one or more processors and memory containing executable instructions, the executable instructions being executable by the one or more processors to perform a method. The method may comprise registering, by a service provider record system, accounts for a plurality of users, authenticating, by the service provider record system, a first user of the plurality of users, receiving a first request to store a first service provider record, the first service provider record by the first user of the plurality of users, the first service provider record being associated with a first project located at a first geographic location, the first request to store service provider record including a first user identifier, one or more first categorical identifiers associated with the first project indicating at least some work performed on the project, and a location identifier associated with the first geographic location, the first project associated with the first service provider record, receiving a request from a first user device for project identifiers located within a section of a geographic area, retrieving a first set of one or more project identifiers based on the request for the project identifiers located within the section of the geographic area, providing the first set of the one or more project identifiers to the first user device, the first set of the one or more project identifiers to be displayed on a first map to the first user device, each particular project identifier of the first set of the one or more project identifiers to be displayed on the first map in a general location where work was performed on the particular project identifier, receiving a request from a first user device for a subset of a first set of project identifiers located within a subsection of the geographic area, retrieving the subset of the first set of project identifiers located within a subsection of the geographic area based on the request for the subset of the first set of project identifiers located within the subsection of the geographic area, providing the subset of the first set of the one or more project identifiers to the first user device, the subset of the first set of the one or more project identifiers to be displayed on a second map the first user device, each particular project identifier of the subset of the first set of the one or more project identifiers to be displayed on the second map in a general location where work was performed on the particular project identifier, receiving, from the first user device, a selected project of the subset of the first set of the one or more project identifiers, the selected project being the first project, providing to the first user device, based at least in part on the first service provider record, a project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project, receiving, from the first user device, a selection of the link to the at least one service professional's profile page associated with the selected project, the at least one service professional having performed work on the selected project, and providing, to the first user device, a profile page of the at least one service professional, the profile page including contact information of the at least one service professional.

### BRIEF DESCRIPTION OF THE DRAWINGS

FIG. 1 depicts a block diagram of an example environment capable of collecting and providing service provider records associated with projects to any number of digital devices over any number of networks.

FIG. 2 depicts a block diagram of an example service provider record system according to some embodiments.

FIG. 3 depicts a flow chart of retrieval of service provider records according to some embodiments.

FIG. 4 depicts an example of a user's profile page on the service provider record system according to some embodiments.

FIG. 5 depicts an example of a map showing the geographical location service provider records according to some embodiments.

FIG. 6 depicts a flow chart of the method of a user interacting with the map of FIG. 5 to search for service provider records.

FIG. 7 depicts an example of a search query based on one or more search criteria according to some embodiments.

FIG. 8 depicts an example of search results based on a search query according to some embodiments.

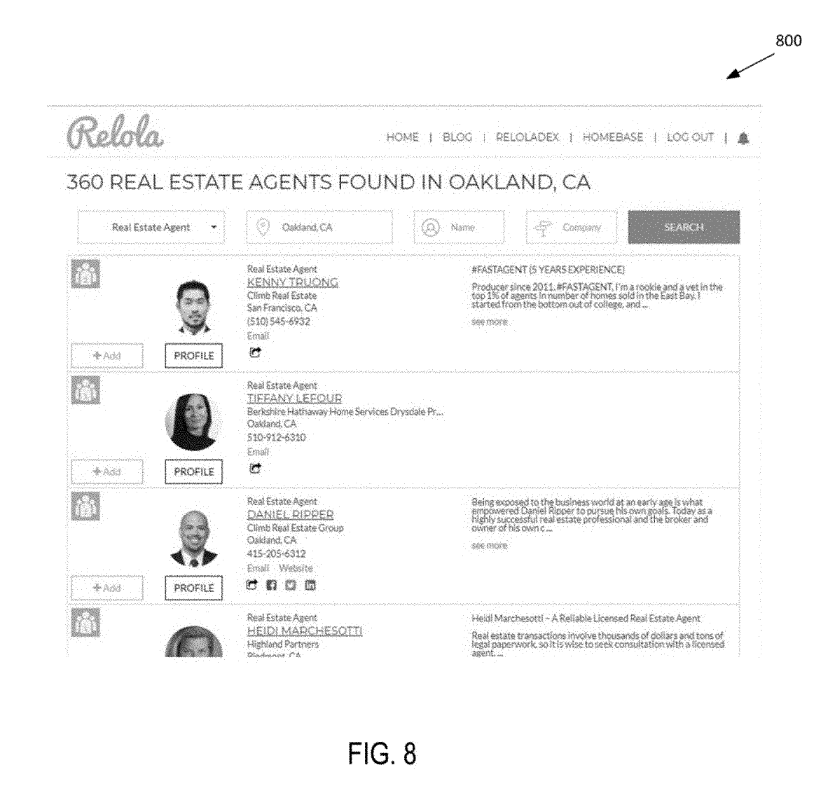

FIG. 9 depicts an example of a service provider's webpage on the service provider record system according to some embodiments.

FIG. 10 depicts an example of a map showing service provider records submitted to the service provider record system by a particular service provider according to some embodiments.

FIG. 11 depicts an example of a service provider record according to some embodiments.

FIG. 12 depicts a flow chart of a method of submission of a service provider records according to some embodiments.

FIG. 13 depicts a flow chart of a method of a user navigating service providers according to some embodiments.

FIG. 14 depicts an example of a project page according to some embodiments.

FIG. 15 depicts a block diagram of an example computing device according to some embodiments.

### DETAILED DESCRIPTION

Different websites and/or different applications may retrieve and store service provider records to a centralized system that manages, stores, and retrieves content based on the criteria of the request (e.g., the user making the request, timeline, location, and/or other information). As a result, a centralized system, such as a service provider record system, may provide content to multiple different web pages and applications. The different web pages and applications may present service provider records from the service provider record system 106 as if the content was being provided by the entity that owns or operates the web pages or applications.

In some embodiments, a website provides or otherwise generates a web page with a section of embedded code. The embedded code, initially provided by a service provider record system, may generate a section (e.g., a portion) of the web page. The section of the web page may be integrated into the web page such that the entire web page, including content from the generated section, appears to be from the same source. The embedded code, however, may provide a request for service provider records from the service provider record system while the rest of the content of the web page is provided by an owner or operator of the web page. The request for service provider records may include, for example, a domain identifier associated with the web site, web page, owner, and/or operator. The service provider record system may retrieve service provider records based on the domain identifier and provide the content back to the requesting web page for display as a part of the web page.

In some embodiments, a first user, registered and authenticated by the service provider record system, may request to store a first service provider record. The first service provider record may be associated with a first project located at a first geographic location. The first request to store the first service provider record may include an uploading user identifier, one or more first categorical identifiers associated with the first service provider record, and a first project associated with the first service provider record. The service provider record system may store the first service provider record in a service provider record datastore. A second user, registered and authenticated by the service provider system, may request to store a second service provider record. The second service provider record may be associated with the first project located at the first geographic location. The second request to store the second service provider record may include an uploading user identifier, one or more first categorical identifiers associated with the second service provider record, and the first project associated with the second service provider record. The service provider record system may store the second service provider record in the service provider record datastore. A third user may request to retrieve the first project located at the first geographic location. The server provider record system may retrieve the first and second service provider records associated with the first project located at the first geographic location. In some embodiments, a project is a real estate listing, a job completed by a professional such as a plumber, an electrician, a carpenter, and the like.

In various embodiments, projects are also categorized by categorical identifiers. In various embodiments, a project is a landmark, an activity, a place of business, such as a restaurant, a grocery store, a clothing shop, etc. A plurality of service provider records or reviews may be associated with one project, however, one service provider record may be associated with one project.

In some embodiments, the service provider record system may provide service provider records based on tags, content creator, type of content creator (e.g., profession and/or services provided), time of creation, geographic location and the like. The service provider record system may provide different content to a wide variety of different web pages (e.g., provided and maintained by different third-party owners), web sites, and/or applications thereby enabling different web pages, web sites, and/or applications to rely on centralized content provided by the service provider record system without recreating the content and/or embedded code at each web page, web site, and/or application.

In various embodiments, the service provider records displayed in a user interface may appear to be a part of the web page, web site, or application (e.g., from the owner or operator of the web page, web site, or application). It will be appreciated that the service provider record system may enable the delivery of service provider records such that it appears to be coming from the web page, web site, or application thereby keeping customers and/or viewers of the user interface to be engaged with the original domain (e.g., the web page, web site, or application).

Further, it will be appreciated that the service provider record system may receive service provider records from different creators. The service provider records from different creators may be provided to a group of different web pages, web sites, and/or applications. As a result, centralized service provider records generated from one or more members may be leveraged by different sites. In some embodiments, a user may enable their service provider records to be stored in the service provider record system and may further make selections to enable their service provider records to be provided to a group or subset of web pages, web sites, and/or applications such that their service provider records appears to be a part of the web page, web site, or application (e.g., from the owner or operator of the web page, web site, or application). In some embodiments, service provider records of the same project are grouped together and shown together on a project profile page. Each of the service provider records may provide a link to the user who submitted the respective service provider. A viewer of the service provider record may choose to add the user who submitted the respective service provider to the viewer's service provider network.

In one example, a real estate web page of a real estate company may provide a user interface depicting different real estate properties. The real estate web page may include a first embedded code that retrieves a map of a location. The map may be retrieved from the service provider record system or from a third-party map provider (e.g., Google Maps, Mapquest, or the like).

The embedded code may also provide a service provider records request to a service provider record system. The service provider record system may receive the service provider records request and, based at least in part on the domain identifier associated with the sending web page or application, retrieve the requested service provider records. In one example, the service provider record system may retrieve service provider records based on the search criteria and location identifiers (e.g., coordinates or other location information) associated with the map. The service provider record system may deliver the retrieved service provider records to the real estate web page and/or a user's digital device.

In some embodiments, the service provider record system may retrieve a profile page of one particular service provider. The profile page may include contact information for the particular service provider. The profile page may also include any number of links to other serve providers recommended by the particular service provider. In one example, in addition to contact information, the particular service provider's profile page may show at least one project associated with specialized work of the particular service provider as well as the particular service provider's selected service providers.

In various embodiments, the service provider record system may retrieve a plurality of service providers which fit the search criteria provided to the user interface, the user may select one of the plurality of service providers displayed on the user interface, and service provider record system will retrieve the profile page of the selected service provider.

In various embodiments, the service provider record system may categorize a service provider record, or review, as an insight review or an opinion review. An insight review may be submitted by a user who is a professional in a particular career field, such as a real estate broker with the National Association of Realtors, submits a review on a real estate listing. An opinion review may be submitted by a user who is not in a career field associated with the project associated with the review. For example, a real estate broker from the above example may review a restaurant that he/she frequents and provide an opinion review. A chef associated with a culinary association may submit a review on a restaurant, and service provider record system may categorize that review as an insight review. In some embodiments, service provider record system determines if a review is categorized as an opinion review or an insight review. In various embodiments, the user chooses to categorize a review as an opinion review or an insight review when the review is submitted.

In other embodiment, service provider record system generates a report documenting a navigational path between an originating service provider to subsequent service providers. The report may include navigational statistics over a period of time such as the number of unique users to visit a particular service provider's profile page, the number of service provider record accessed by users, the most popular service provider record, number of users who added the service provider to their selected service providers, navigational path of how user arrived at the service provider's page, and/or navigational path showing which of the service provider's selected service providers the user visited next. These navigational statistics may be useful for service providers to determine service provider connections which provided the most number of visits from users, and which of the particular service provider's selected service providers is most popular.

It will be appreciated that service provider records may include any kind of digital content or media, including, but not limited to pictures, text, video, sound, graphics, icons, interactive programming, or any combination of the above.

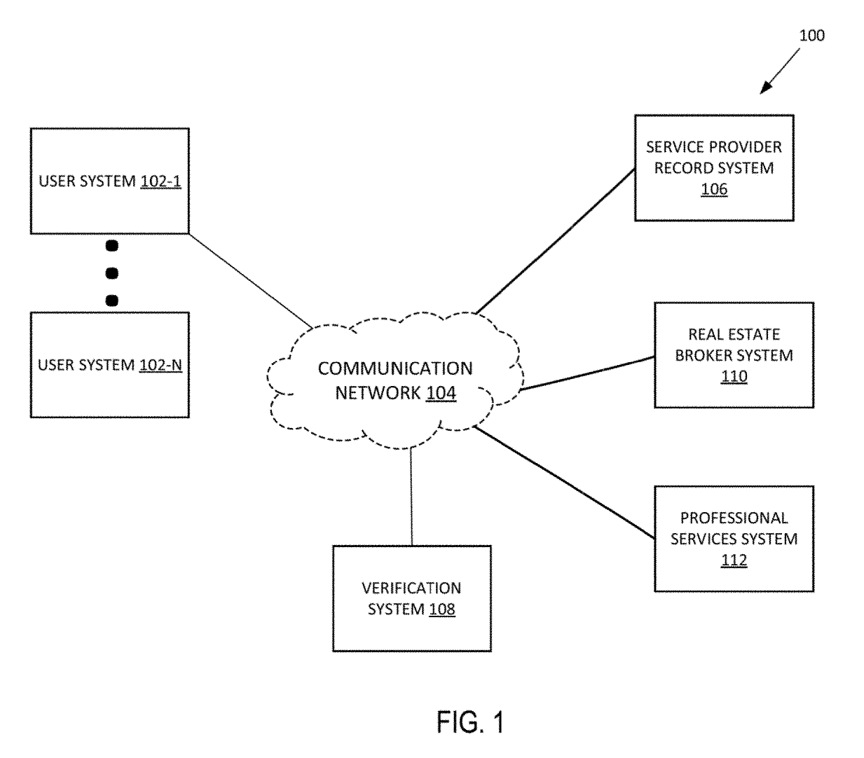

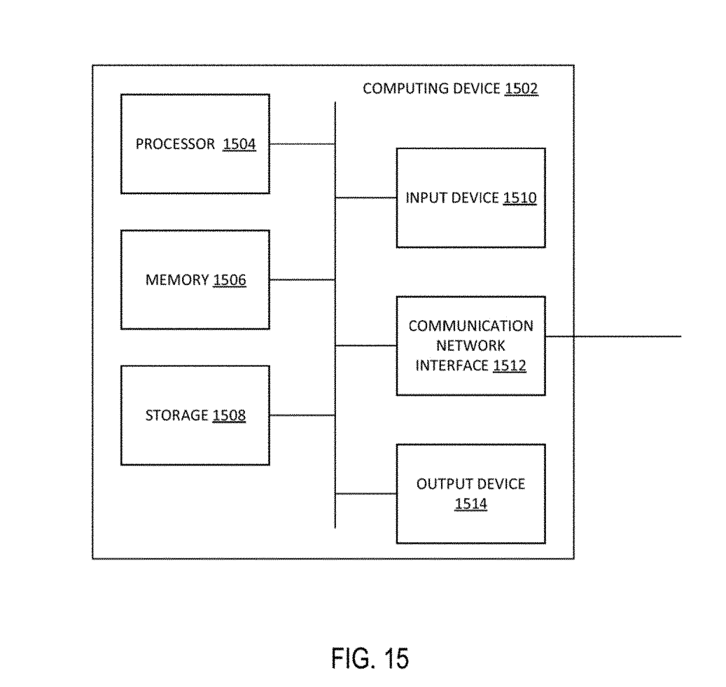

FIG. 1 depicts a block diagram of an example environment 100 capable of collecting and providing service provider records associated with projects to any number of digital devices over any number of networks 104. In this example, the environment 100 includes user systems 102-1 to 102-N (individually, user system 102 collectively), communication network 104, service provider record system 106, verification system 108, real estate broker system 110, and professional services system 112. The user systems 102-1 to 102-N, service provider record system 106, and verification system 108 may each be or include any number of digital devices. A digital device is any device with a processor and memory. Digital devices are further discussed herein (e.g., see FIG. 15).

In some embodiments, user system 102-1 may be configured to facilitate communication between users and other associated systems. In some embodiments, user system 102-1 is a service provider. In some embodiments, the user system 102-1 may be or include one or more mobile devices (e.g., smartphones, cell phones, smartwatches, table computer, or the like), desktop computers, laptop computers, and/or the like.

In some embodiments, communication network 104 represents one or more computer networks (e.g., LANs, WANs, and/or the like). The communication network 104 may provide communication between any of user system 120, service provider record system 106 and domain system 108. In some implementations, the communication network 104 comprises computer devices, routers, cables, uses, and/or other network topologies. In some embodiments, the communication network 104 may be wired and/or wireless. In various embodiments, the communication network 104 may comprise the Internet, one or more networks that may be public, private, IP-based, non-IP based, and so forth.

In some embodiments, users may interact with user system 102-1-102-N using, for example, a web browser or mobile application to communication with other users, access web pages on the verification system 108, and/or interact with applications on their own devices to generate or receive service provider record from the service provider record system 106.

In some embodiments, the service provider record system 106 provides a system to allow the user of user system 102 to authenticate the user's login and password. The service provider record system 106 may further receive a service provider request and/or create a search query based on one or more search criteria. The search criteria may be based, at least in part, on information provided in the search request. The user may interact (e.g., click) with one or more elements in the search results. The search results may include a plurality of service providers which fit the user's search criteria. By selecting one or more of the plurality of search providers of the search results, more detailed information regarding a particular service provider may be depicted, such as ways to get in contact with the selected service providers. The user may choose to connect with a service provider and add the service provider to their selected service provider network (e.g., adding the selected service provider(s) to their own profile to enable others to find the user's profile and view that user's selected service provider(s)). Once a service provided is added to a user's service provider network, the service provider record system 106 may provide notification to the user of a new service provider record from the particular service provider, or another service provider connected to the connected service provider. In some embodiments, the service provider is a user.

The service provider record system 106 may be configured to display projects and at least some of the associated service provider records. Furthermore, the service provider record system 106 may be configured to filter and organize projects and their associated service provider records according to one or more filter criteria, including categorical identifiers, which may include tags, time stamp of the service provider record, geographical location, the type of review, user identification and/or others. Other filtering criteria could include, but are not limited to, name of project, time project occurred, and/or keywords. The service provider record system 106 may display the output of the search query in the form of a map, of a list, or in other electronic forms. The user may interact with one or more elements in the search results and the embedded code of the web page may provide a service provider request including an identifier associated with the service provider that the user selected.

In various embodiments, service provider records may be provided by the user system 102 to service provider record system 106. Both service providers and projects may be associated with one or more type or categories. A service provider providing a service provider review associated with a project from the same category may be flagged as an insight review. For example, a user who is a real estate broker may provide a service provider review of a home that he/she is listing and trying to sell. A service provider record may be a review. A review may be an opinion review or an insight review.

In some embodiments, an insight review may be submitted by a user who has been verified as a professional in a particular career field, such as a real estate broker who has been verified by a network or group associated with the career field, such as the National Association of Realtors using his/her real estate broker identification number. In one example, a real estate broker verified by the National Association of Realtors submits a review on a home that he/she is listing. That review may be identified as an insight review. An opinion review may be submitted by a user who is not in a career field related to the project associated with the review. Returning to the real estate broker, the broker submits a review on a restaurant that he/she frequents. The review may be an opinion review. A chef whose credentials are verified by a culinary association may submit a review on the same restaurant, and service provider record system 106 may categorize that review as an insight review.

In some embodiments, the service provider record system determines if a review is categorized as an opinion review or an insight review. In various embodiments, the user may manually choose to categorize a review as an opinion review or an insight review when the review is submitted.

The service provider record system may generate a report that tracks or identifies navigational path between a particular service provider to subsequent service providers. For example, a user may navigate the service provider record system from a profile page of service provider A to a profile page of service provider B (which is a selected service provider of service provider A), and subsequently to a profile page of service provider C (which is a selected service provider of service provider B). The service provider record system may generate a report document showing a navigational path from service provider C to service provider A, and from service provider C to service provider B. The report may include navigational statistics over a period of time, these navigational statistics may be useful for service providers to determine service provider connections which provided the most number of visits from users, and which of the particular service provider's selected service providers is most popular. It will be appreciated that compensation or other rewards may be provided (e.g., to the initial profile of service provider A and/or to the profile of service provider B) based on the profile(s) and path(s) that generated connections, views, and/or business.

In some embodiments, the service provider record system 106 collects service provider records created by any number of users (e.g., user systems 102-1-102-N) of a project (e.g., location, facility, landmark, project or the like). The service provider record may be associated with one or more categories (e.g., using tags) with relation to (or in interest of) verification system 108 (e.g., verification system 108 may be a real estate broker association, and the project may be a listing of a real estate property that is for sale). In some embodiments, the verification system 108 receives membership number or other forms of identification determine if a particular user belongs to a professional association.

The user of user system 102, may create an account on the service provider record system 106. The user may upload their contact information, projects, connections with other service providers, and/or reviews as service provider record(s) to the service provider record system 106. The service provider record may be linked or associated with the user (e.g., a user ID), time at which the service provider record was uploaded (e.g., by timestamp), tags identifying categories (e.g., associated with projects, reviews, and/or selected service providers), location information (e.g., map locations or coordinates), and/or the like. In one example, a user of user system 102-1, such as a real estate broker, could create a review of past listings of homes in which he/she was recently involved in sales and/or listings of homes that the real estate broker may have visited. In various embodiments, the real estate broker in the above example may include service provider records indicating impressions or facts regarding homes, schools in the area of a listed property, stores, neighborhoods, and the like.

The service provider record system 106 may include service provider records from any number of users. Any of the service provider records may be associated with any number of user identifiers, time at which that particular service provider record was uploaded, tags, location information, the type of review, and/or the like. Any number of websites or applications may request information from the service provider record system 106 and, based on the criteria (e.g., domain of the web site), the service provider record system 106 may select and/or filter any amount of previously stored service provider record and provide the service provider record back to the requesting website or application.

As a result, the service provider record system 106 may provide different types of information provided by any number of users to any number of web pages and applications. It will be appreciated that, in some embodiments, the same user may provide a request for service provider records from the service provider record system 106 from multiple different websites.

In some embodiments, verification system 108 is a website, a system verifies the service provider as a professional in a particular career field, such as a real estate broker who has been verified by the National Association of Realtors or a photographer who is a member of the Professional Photographs of America.

In some embodiments, the real estate broker system 110 and the professional services system 112 are different third-party domains (from different and independent third-party operators). The real estate broker system 110 may be a website, a system that provides content to a real estate website, a real estate web page, and/or a system that provides support for an application. Professional services system 112 may be a website, a system that provides content to a professional services website, a professional services web page, and/or a system that provides support for an application. In various embodiments, the real estate broker system 110 may be configured to host websites and allow user system 102 to access data from a variety of third-party domains through service provider record system 106 and seamlessly blend them into the display of the domain system. For example, a variety of third-party domain, such as real estate broker system 110 and professional services system 112 may request and receive service provider records submitted by users of other third-party domains. Similarly, users accessing service provider record system 106 from a third-party domain such as real estate broker system 110 may submit a service provider record to service provider record system 106. By accessing service provider records from service provider record system 106, third-party domains, such as real estate broker system 110 and professional services system 112 do not need to store service provider records locally, and service provider records left by users accessing from one domain can be accessed by users accessing from another domain.

Although discussion included herein may discuss web pages or application interfaces without reference to the other, it will be appreciated that systems and methods described herein may apply to applications, application interfaces, web pages, and web sites.

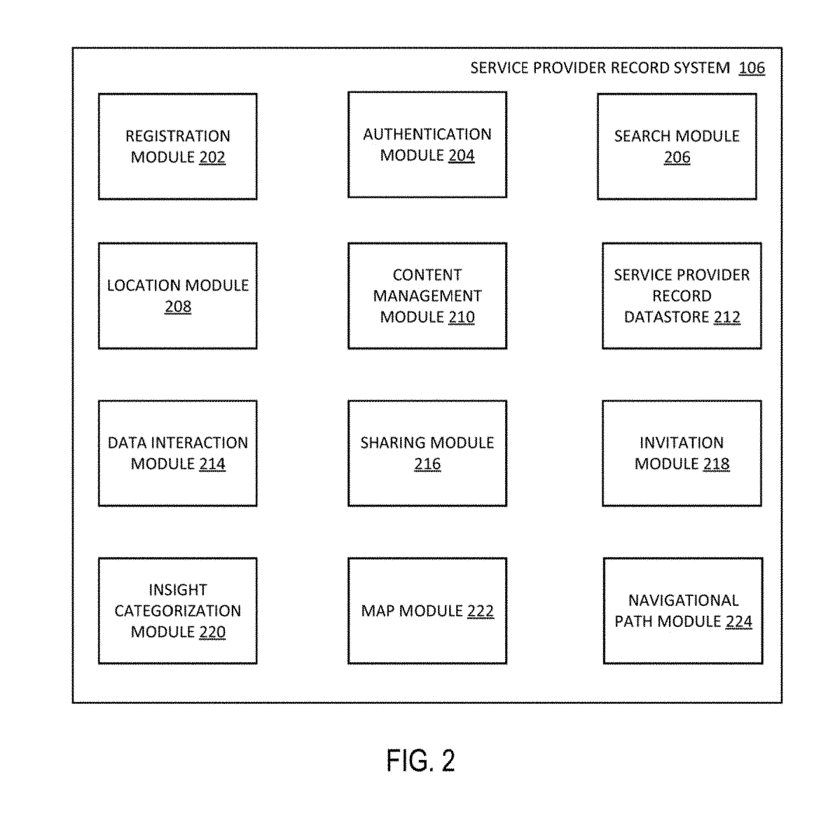

FIG. 2 depicts a block diagram of an example service provider record system 106 according to some embodiments. The service provider record system 106 includes a registration module 202, an authentication module 204, a search module 206, a location module 208, a content management module 210, a service provider record datastore 212, a data interaction module 214, a sharing module 216, a invitation module 218, a insight categorization module 220, map module 222, and an navigational path module 224.

In some embodiments, the registration module 202 may be configured to create accounts for users. The registration module 202 may be configured to update account information for users and user groups. When a new user registers, a user identifier (e.g., a login identifier) and password may be required.

In various embodiments, accounts for users may include user identification information. User identification information may include, for example, an email address, password, phone number, demographic information, and/or the like. Accounts for user groups may include the account information for users who belong to the user group and, optionally, a level of permission (e.g., for record retrieval) associated to one or more user. In some embodiments, registration may be required in order to create and store service provider records associated with a project with the service provider record datastore 212. In various embodiments, a user may be required to be registered and/or login to their account before storing service provider record(s) with the service provider record system 106 and/or retrieving service provider record from the service provider record system 106.

In various embodiments, the registration module 202 may create a user account for each user or user group. The account may be stored with the service provider record system 106 (e.g., with the service provider record datastore 212).

The authentication module 204 may be configured to authenticate a user's login and password. The login and password may be associated with the user's account. The authentication module 204 may authentic a user by comparing the user's login and password with a database of registered users. It will be appreciated that users may be authenticated in many ways including, but not limited to, device identifiers, biometrics, encryption keys, cookies, and/or the like. In some embodiments, the authentication module 204 may make additional requests of membership numbers or other forms of identification to indicate that the user belongs to one or more professional association. The authentication module 204 may communicate with the verification system 108 to determine if a particular user belongs to a professional association. In some embodiments, the authentication module 204 may, after authentication, determine data permissions prior to allowing users to store to content within the content delivery system datastore 216. In some embodiments, the authentication module 204 authenticates the projects and locations associated with service provider record, to determine if they are real projects and not falsified.

In some embodiments, search module 206 is configured to receive a request for a service provider or a service provider record and/or create a search query based on one or more search criteria. The search module 206 may be configured to filter and organize according to one or more filter criteria, including the categorical identifiers, which may include tags, time stamp of the service provider records, geographical location, the type of review, user identification and others. Other filtering criteria could include, but are not limited to, name of project, time project occurred or keywords. The search module 206 may output the results of the search query in the form of a map, a list, or in some other electronic forms. The user may interact with one or more elements in the search results and the embedded code of the web page may provide a service provider request including an identifier associated with the service provider that the user selected.

The location module 208 may be configured to determine or receive geographic location (e.g., location information) regarding a project associated with service provider record. As discussed herein, in some embodiments, a service provider record may be associated with a project as well as geographic location information (e.g., the service provider record may include restaurant reviews in a city and may be associated with GPS or address information). It will be appreciated that the location module 208 may also determine or receive geographic location information regarding a cluster of projects located in proximity to each other and/or a cluster of projects with some common categorical identifier. For example, location information may be used by a user of the service provider record system 106 to determine the location of real estate listing closest to another real estate listing or other project. In some embodiments, location module 208 may utilize or receive GPS information, Wi-Fi signals, and/or cellular signals to determine or assist in determining location information associated with new service provider record to be stored or service provider record to be retrieved.

In some embodiments, the content management module 210 may be configured to manage (e.g., create, read, update, delete, provide and/or otherwise access) service provider records. In one example, service provider records may be associated with a project or location and stored in the service provider record datastore 212. In some embodiments, a project or location may have multiple reviews associated with them. The type of review left by users of the service provider record system 106 is dependent on who left the review. For example, a real estate listing may include an insight review left by the listing real estate broker who is a verified member of the National Association of Realtors or some other real estate broker association, or other real estate brokers who had previously viewed the real estate listing, while an opinion review may be left by a user of service provider record system 106 who is not in the real estate career field, or is not a real estate broker verified by the National Association of Realtors. The content management module 210 may categorize or associate service provider records with location information (such as global positioning system, GPS, coordinates) generated by the location module 208, security permission of a user, and/or links to other social networking websites such as Facebook®, Twitter®, and others. In some embodiments, content management module 210 comprises a library of executable instructions which are executable by a processor for performing one or more of the aforementioned management operations.

The service provider record datastore 212 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and/or the like). The service provider record datastore 212 may store service provider records created or retrieved from different domains, user accounts, and/or the like. In some embodiments, content may be saved to or retrieved from different datastores of the service provider record datastore 212 according to the domain that the user is currently accessing.

In addition to service provider records, categorical identifiers may also be saved in the service provider record datastore 212 to facilitate the retrieval of the data. Categorical identifiers may include domain identifiers, user identifiers, geographical location of the project, type of review or project associated with the service provider record, time stamp of the service provider record, tags, and/or others.

In some embodiments, service provider record datastore 212 may store the profile pages of users who have been authenticated by authentication module 204. In various embodiments, service provider record datastore 212 may store the profile pages of all users of service provider record system 106. In one example, the profile page of users of service provider record system 106 are stored in their respective domain. For example, profile pages of real estate brokers may be stored on real estate broker system 110.

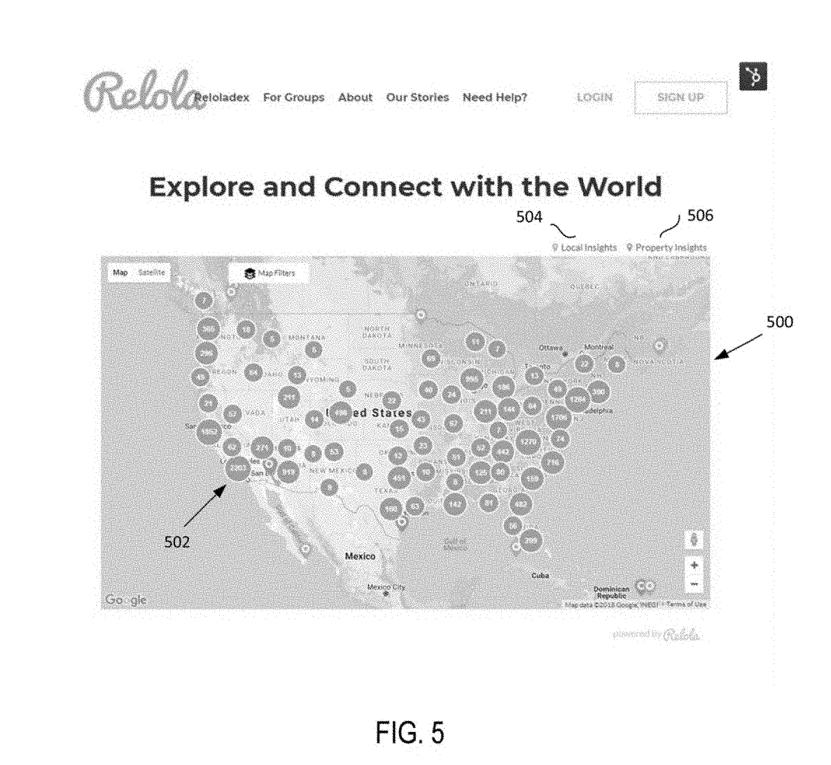

The data interaction module 214 may be configured to process service provider record interaction requests which may occur when a user interacts (e.g., click) on an embedded element (e.g., link) within a web page, web site and/or application. For example, a real estate web page of a real estate company may provide a user interface depicting different properties. The real estate webpage may include embedded code that retrieves a map, provided by map module 222, of a location. In other embodiments, the map is provided by a third-party mapping service. The real estate webpage may retrieve overlay information (e.g., elements such as icons) from the service provider record system 106 to provide over the map (e.g., balls, flags, or other indications of additional content associated with different locations depicted in the map), such as the example map shown on FIG. 5. For example, embedded code within the web page may provide a request for overlay information and/or location information to the service provider record system 106. The service provider record system 106 may then provide an overlay to a user device and/or the requesting web page for the overlay to be displayed over the map.

In various embodiments, if the user interacts with one or more elements (e.g., balls, pins, flags, or the like) of the overlay, the embedded code of the web page may provide a content request including an identifier associated with the element that the user selected. The content request may, in some embodiments, include a domain identifier and/or any other information. The data interaction module 214 may retrieve content associated with the selected element and provide the retrieved content to the web page and/or requesting user device.

In another example, when a user clicks on an embedded code, the user's device may provide a content interaction request to data interaction module 214. The data interaction module 214 may facilitate the content interaction request by determining the interaction identifier and sending the information to content delivery system datastore 216. In various embodiments, before providing the overlay, the service provider record system 106 may confirm that the requesting user and/or web page has rights to the content associated with elements of the overlay (e.g., by confirming that the requesting domain has rights and/or authenticating the identity of the user by confirming a password) thereby preventing a user from interacting with and/or viewing elements over a map that are associated with content that they do not have rights to view.

The sharing module 216 may be configured to receive permissions and enable users to share service provider records in an electronical mail (email) or social networking website such as Facebook®, Twitter®. In various embodiments, the sharing module 216 may also provide notification(s) to other users when they are associated with a user that has stored new user contents. In one embodiment, the sharing module 216 may provide push or pull notification(s) to other people on the user's service provider network. The sharing module may be further configured to send referrals to their user selected service providers.

It will be appreciated that users may generate user content and store the user content in the content delivery system datastore. The user may invite other users or groups of users to access their content using the sharing module 216. For example, the user may provide user identifiers to invite others to receive or be able to view the user's content. The sharing module 216 may retrieve user address information (e.g., email addresses, chat addresses, instant message addresses, or the like) from each user's account. In some embodiments, the user may provide the sharing module 216 address information without the sharing module 216 retrieving the address information.

In various embodiments, the sharing module 216 may be configured by a user to enable social networks to receive content generated by the user and/or may be configured to retrieve the content from the social networks (e.g., from the user's Pinterest site) to be stored in the content delivery system datastore 216.

In some embodiments, the invitation module 218 may provide invitations to others to receive or otherwise access content of the user. The invitees may respond by proving an invitation acceptance to the service provider record system 106. If an invitation is accepted, the invitation module 218 may generate a data right associated with the content creator and the invitee to enable the invitee to receive and/or access service provider record from the service provider record creator (e.g., the service provider record from the user stored in the service provider record datastore 212). In some embodiments, invitations can be sent to others by importing a contact list associated with an email address of the user. In some embodiments, service provider records may not be available to those who are not specifically approved by the user to receive or access their content unless marked as “public” for all users (in which case the data rights for such content may indicate that the content is available to all).

In some embodiments, invitation module 218 may be configured to invite users to view or create service provider records associated with a particular project, or a cluster of projects, or a cluster of projects with a common categorical identifier. Invited users may or may not be registered as a user or as a part of a user group. For example, a real estate broker who belongs to the National Association of Realtors may wish to invite fellow real estate brokers, who may or may not be on the real estate broker's network, to share.

In some embodiments, insight categorization module 220 may be configured to determine if a review submitted by a user can be categorized as an opinion review or an insight review. A service provider record, associated with a category (e.g., an identifier associated with different groupings such as real estate, home sales, plumbing, paining, construction, remodelling sub-contractor, stucco, kitchen, bathroom, landscaping, arborists, pest control, and/or the like), submitted to service provider record system 106 by a user who has been verified by authentication module 204 as a professional in a particular career field of the category, may be categorized as an insight review. A service provider record of a first category submitted to service provider record system 106 by a user who has been verified by the authentication module 204 as a non-professional or a professional in a particular career field of a different category may be categorized as an opinion review. In various embodiments, insight categorization module 220 is optional, and service provider record system 106 allows users to choose to categorize a review as an opinion review or an insight review when the review is submitted.

In some embodiments, the map module 222 provides a map of a location from third-party map provider (e.g., Google Maps, Mapquest, or the like). The map may include icons associated with projects over a large geographic area, such as the example map shown in FIG. 5. Icons of map 500 of FIG. 5 are combined by geographic location into cluster 502. Map module 222 facilitates the user's access to service provider records by displaying them on the map 500, and allowing the user to zoom in or out to display a smaller or larger geographic region respectively. As a user zooms in or out to display a smaller or larger geographic region, the location and the number of icons in a cluster may change. Map module 222 also allow the user to filter and organize projects and their associated service provider records according to one or more filter criteria, including categorical identifiers. Service provider records can also be filtered by local insights and property insights using local insight icon 504 and property insights icon 506. In some embodiments, the map module 222 may update, or add, an icon to map 500, in real time as new service provider records are received and stored in service provider record datastore 212. In some embodiments, local insights are service provider records provided by users with knowledge of the local area around the geographic location of the service provider record. In one example, property insights are service provider records associated with real estate listings.

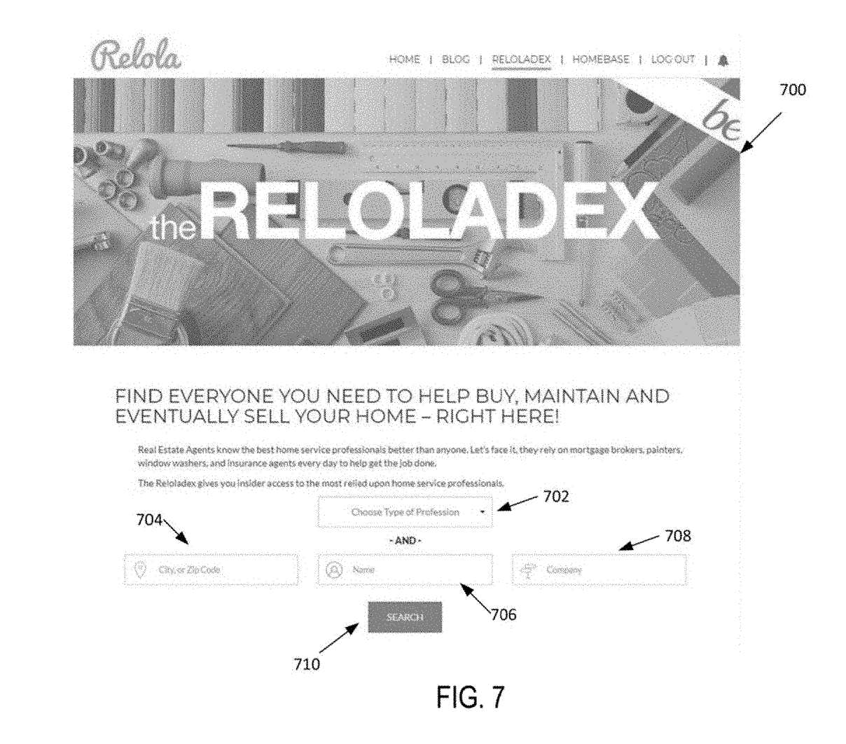

In one example, the navigational path module 224 tracks the navigational path any given user takes from an origin service provider to subsequent service providers. A user can navigate to an origin service provider via map 500 or search query 700 of FIG. 7. For example, a user can navigate map 500, select a real estate listing, navigate to the listing's real estate broker's profile page, and select one of the real estate broker's selected service providers, such as a plumber. In response to the selection, the service provider record system 106 may navigate to the plumber's profile page. The user may subsequently select one of the plumber's selected service providers, such as a general contractor. The navigational path module 224 may track the path from the real estate listing, to the real estate broker, to the plumber, and to the general contractor. In other embodiment, navigational path module 224 may generate a report documenting all or part of the navigational path from the real estate broker to the general contract, and notify all service providers, from the originating real estate broker to the destination general contractor, and every contact in between. The report may include navigational statistics over a period of time and may be sent to service providers periodically.

A module may be hardware or software. In some embodiments, the module may configure one or more processors to perform functions associated with the module. Although different modules are discussed herein, it will be appreciated that the service provider record system 106 may include any number of modules performing any or all functionality discussed herein.

In one example, the embedded code on a real estate web page may provide a collection of crowd-sourced reviews which may be stored on the web site associated with the real estate web page, partners of the real estate web page, and/or service provider record system 106.

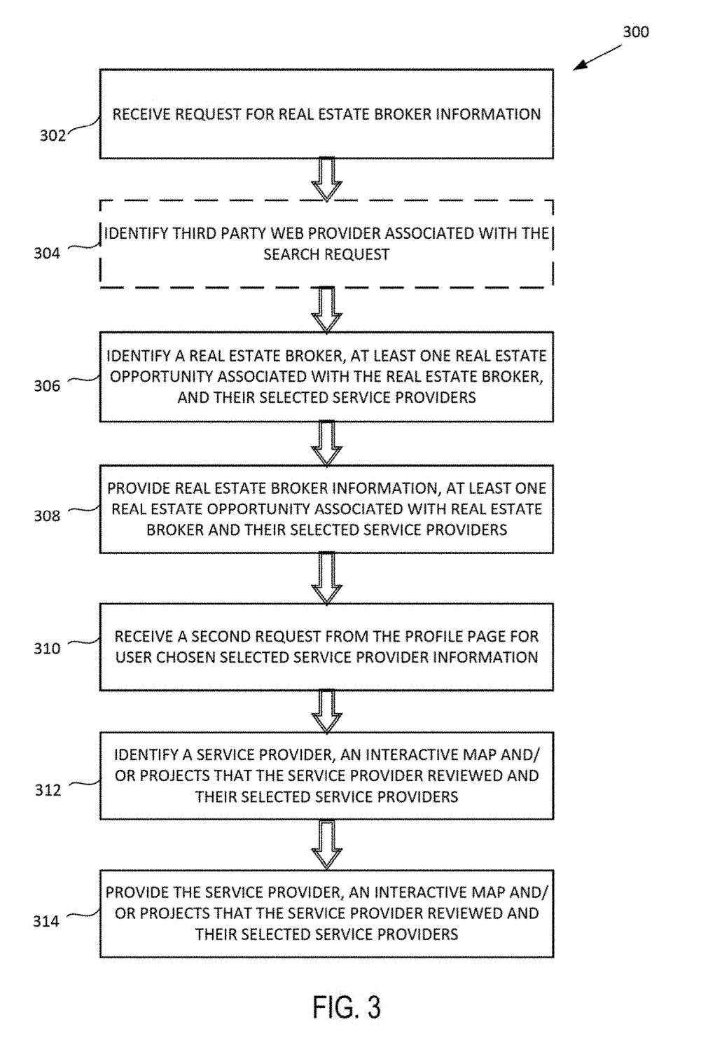

FIG. 3 depicts a flow chart 300 of retrieval of service provider records according to some embodiments. In step 302, the search module 206 receives a request for real estate broker information. The user of user system 102 may input into a search query field 700 of FIG. 7. The search query may be based on one or more search criteria, for example. When making a search query, user of user system 102 may choose the type of profession to search for in field 702, a city or zip code may be inputted into field 704, name of the professional into field 706 and name the company into field 708. In various embodiments, fields 704, 706, 708 may be left blank if so desired. To submit the search request to search module 206, the user may select search icon 710.

In optional step 304, service provider record system 106 may identify the third-party web provider associated with a web page (e.g., the web page from which the request for real estate broker information was received). The web page 700 (see FIG. 7) may be a part of the embedded code, linked within the embedded code, or provided by the service provider record system 106. The request for service provider records may include, for example, a domain identifier associated with the web site, web page, owner, and/or operator. The service provider record system may retrieve service provider records based on the domain identifier and provide the content back to the requesting web page for display as a part of the web page. In some embodiments, the search criteria is based on the domain identifier (e.g., the same search provided by different domains may result in information being provided from different service provider records. In various embodiments, step 304 may be omitted.

In step 306, the search module 206 sends the request for real estate broker information to service provider record datastore 212 to identify the real estate broker, at least one real estate opportunity associated with the real estate broker, and their selected providers. The service provider record datastore 212 may access a datastore associated with the domain that the user is currently accessing. In some embodiments, in addition to the service provider records, the service provider record datastore 212 may also store view/update permission.

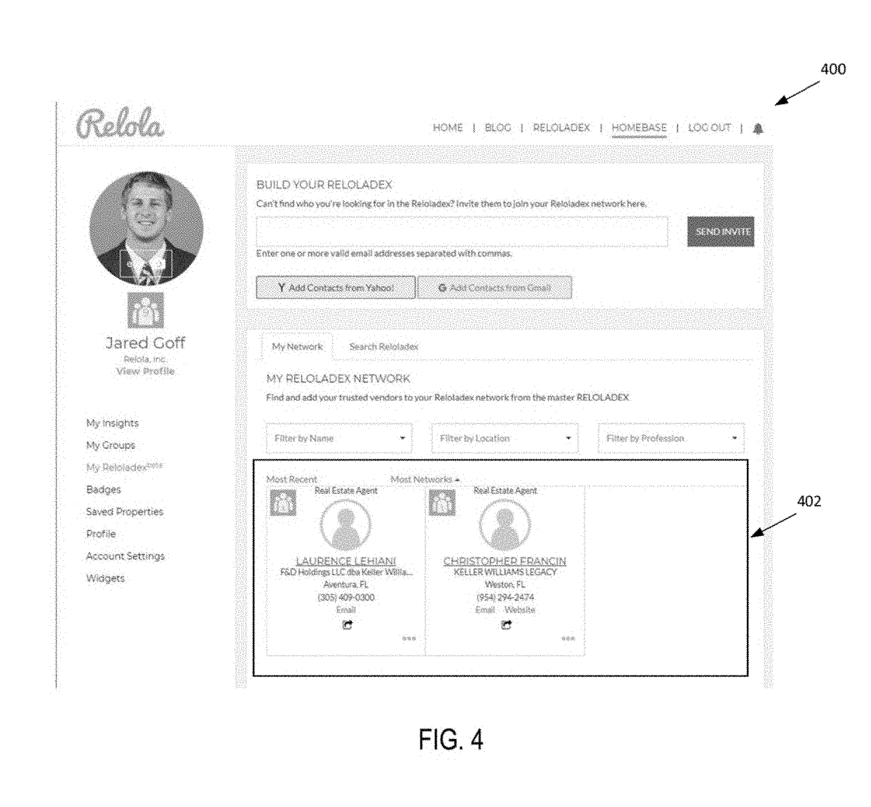

In step 308, the service provider record datastore 212 may provide real estate broker information, at least one real estate opportunity associated with the real estate broker (e.g., a current real estate listing), and their selected service providers by sending this information to an output device of user system 102. The output device of user system 102 may receive this information and display this to the user. An example of the real estate information, at least one real estate opportunity associated with the real estate broker and their selected service providers can be found in FIGS. 4, 9, and 10.

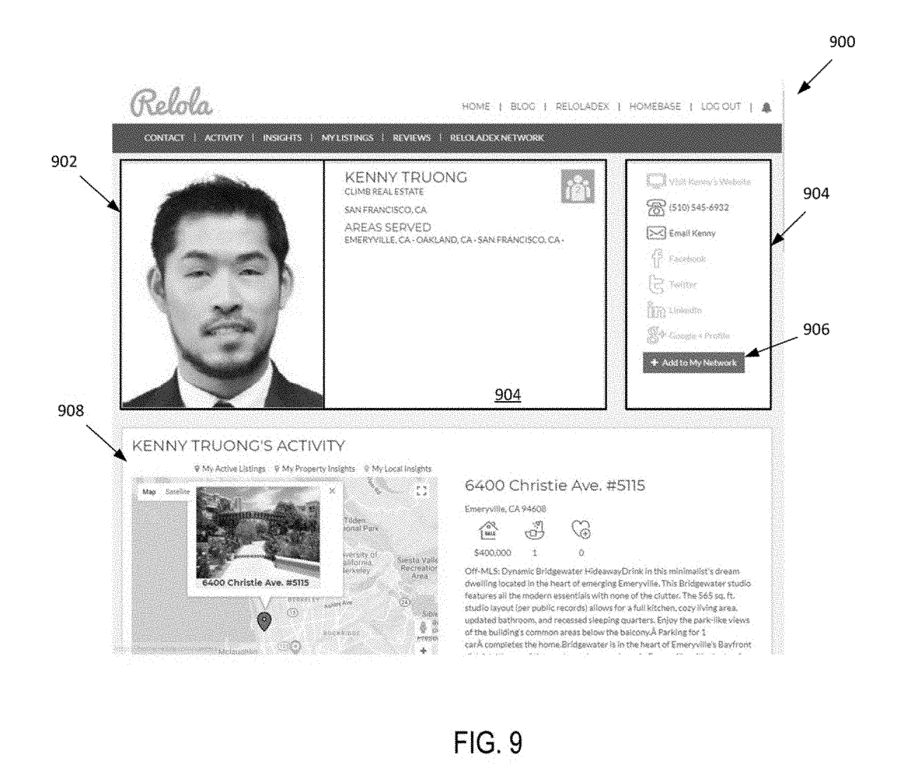

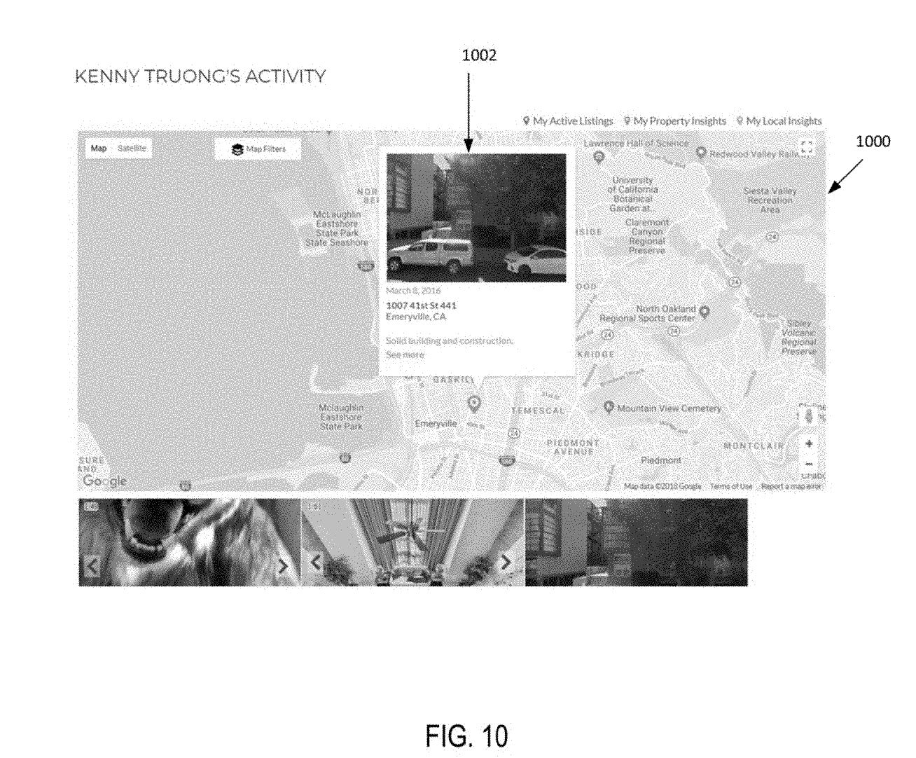

A profile page 900 of a real estate broker is shown in FIG. 9. The profile page 900 includes a profile picture 902, a listing of some vital information regarding the real estate broker (such as the real estate broker's name, company, which city the real estate broker resides) and areas served by the real estate broker. Map 1000 of FIG. 10 shows at least one real estate opportunity 1002 associated with the real estate broker. FIG. 4 depicts an example of a user's profile page 400, area 402 illustrates the region of the web page which shows the selected service providers of the user. Users may choose one of the real estate broker's selected service providers.

In step 310, the search module 206 receives a second request for the profile page for the user's selected service provider information. The service provider record datastore 212 may access a datastore associated with the domain that the user is currently accessing. In various embodiments, the service provider record datastore 212 may retrieve information without consideration of domain.

In step 312, the search module 206 sends the request to the service provider record datastore 212 to identify the selected service provider, an interactive map, and/or projects that the selected service provider reviewed and their selected service provider(s) (in other words, the selected service provider of the selected service provider).

In step 314, the service provider record datastore 212 may provide the selected service provider, an interactive map, and/or projects that the selected service provider reviewed and their selected service provider. An example of the interactive map can be found on FIG. 10. FIG. 10 depicts an example of a map 1000 showing service provider records submitted to the service provider record system 106 by a particular service provider. Image 1002 is a thumbnail picture of one of the service provider records provided by the real estate broker whose profile page map 1000 belongs to.

It can be appreciated that the service provider record system 106 may provide service provider records from professions other than real estate brokers. For example, service provider record system 106 may provide service provider records from professionals such as carpenters, photographers, plumbers and the like, and the projects that the service provider may provide service provider records to may be associated with projects, or jobs that these professionals had previously completed.

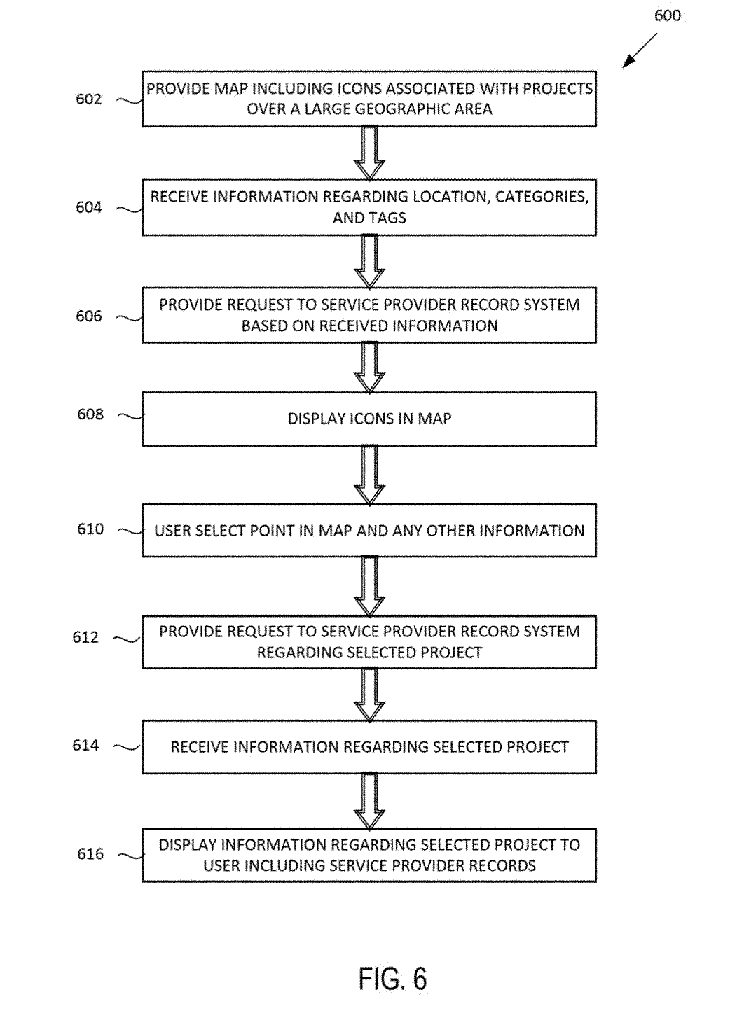

FIG. 6 depicts a flow chart 600 of the method of a user interacting with the map of FIG. 5 to search for service provider records. In step 602, the map module 222 provides map 500 of FIG. 5. In various embodiments, a map request is received from a user that downloaded a web page with embedded code. The map 500 may include icons associated with projects over a large geographic area to output device of user system 102. In some embodiments, icons are combined by geographic location into cluster 502. The map may include icons associated with projects over a large geographic area, such as the example map shown in FIG. 5.

In step 604, the map module 222 receives information regarding geographic location, categories, and tags and other filter criteria from user system 102. In one example, the service provider record system 106 may provide the map 502 a user device 102. A user of the user device 102 may view the map 500, and input a request for additional information. The request for additional information may include the geographic location, categories, and/or tags. The map module 222 may receive the request for additional information. In some embodiments, user system 102 may provide instruction to zoom or pan around the geographic location shown in map 500. The user can filter and organize projects according to one or more filter criteria, including categorical identifiers.

In step 606, in response to the received information from step 604, the map module 222 may send a request to the service provider record datastore 212. The service provider record datastore 212 may receive the request and filter the service provider records according to the received information. The map module 222 may receive the filtered service provider records from the service provider record datastore 212 and display the projects associated with the filtered service provider records in the form of maps on a map such as map 500 of FIG. 5.

In step 608, the map module 222 updates the map 500 and project icons associated with the filter service provider records from step 606.

In step 610, the user may zoom in or out of the map 500, or the user may pan around the geographic location shown in map 500. The user may obtain a preview of the project 1002 with additional information of an icon on the map the point representing a geographic location of a project. After a preview, the user may select an icon on the map 500 to receive further information regarding the project associated with the icon.

In step 612, the map module 222 interprets the user's selection in step 610, and the map module 222 may send a request to the service provider record datastore 212 for the project associated with the service provider record associated with the user's selection.

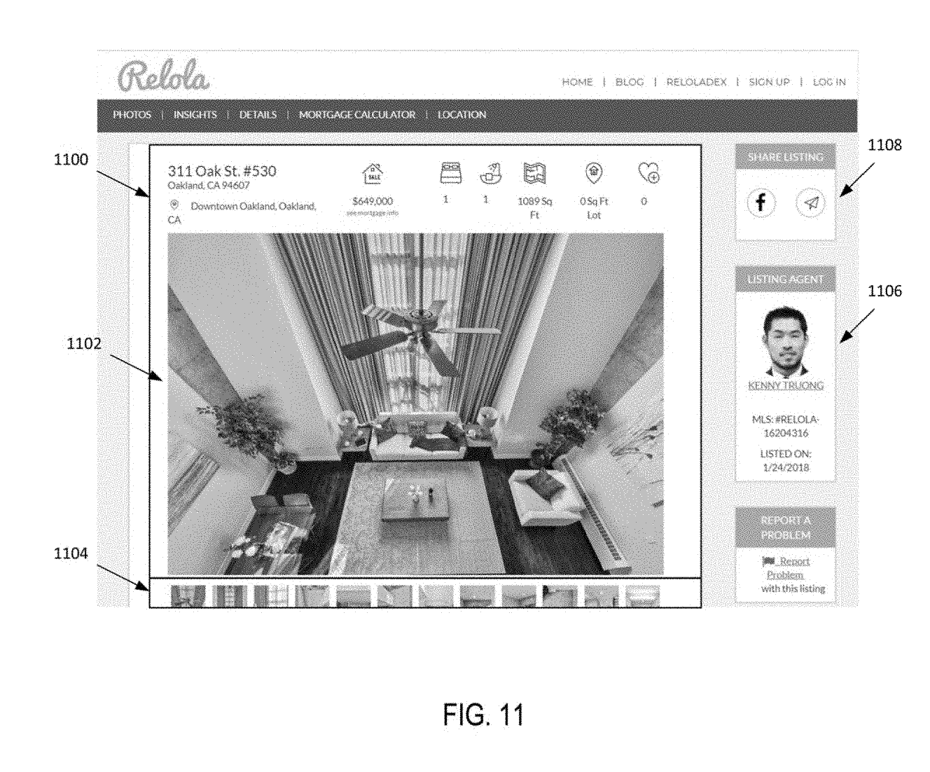

In step 614, the service provider record datastore 212 receives the request of the user's selection from map module 222 and provides the additional information regarding the project, or a project page 1100 of FIG. 11, including the service provider records associated with the user's selected project. The project page 1100 may include information such as hours of operation, address, telephone number, images, video and other digital media to give visitors to the project page more information about what the project is about. The service provider record may include any kind of digital content or media, including, but not limited to pictures, text, video, sound, graphics, icons, interactive programming, or any combination of the above.

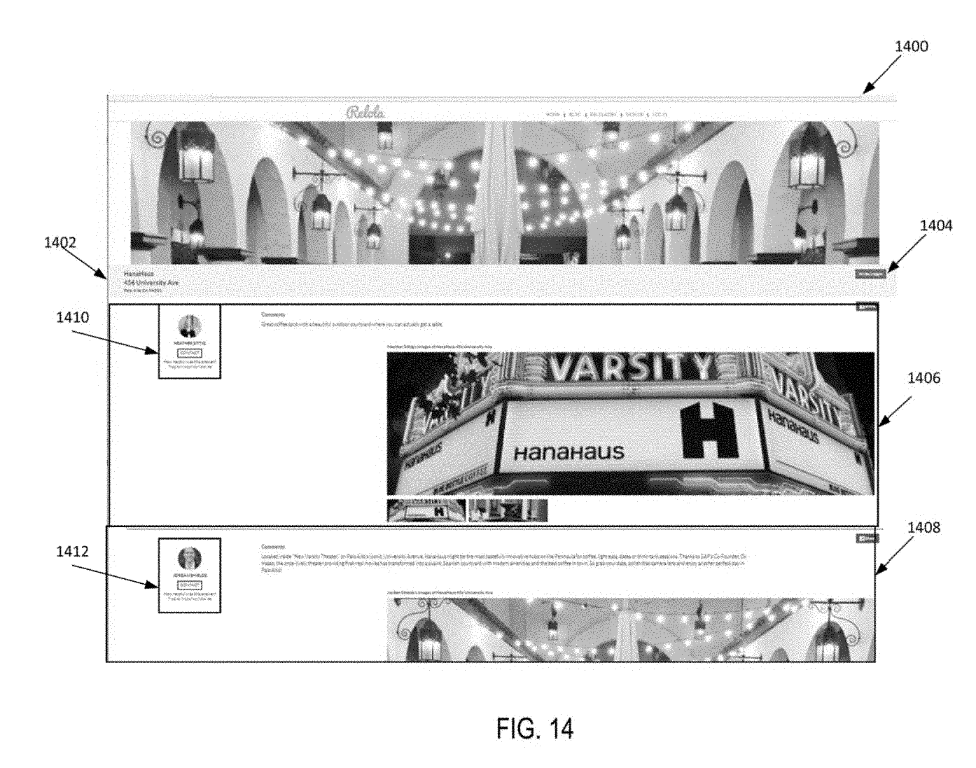

In step 616, the output device of user system 102 may receive the project page associated with the user's selection from service provider record datastore 212 and displays the project page, such as project page 1400 of FIG. 14 to the user. The project page 1400 may include detailed information regarding a movie theatre, information regarding the address of the project is shown in 1702, a first user accessing the project page 1400 may add a review or service provider record for this project by selecting link 1704. The project page 1400 disclosed in FIG. 14 includes two service provider records, 1706 and 1708. Service provider records 1706 and 1708 includes textual content as well as image content. User 1710 and 1712 submitted service provider records 1706 and 1708 respectively. Users 1710 and 1712 displays an image of the user and a link for other users to. The first user navigating project page 1400 may connect to users 1710 and 1712 by selecting the link and add one or both of users 1710 and 1712 to their network. By connecting to one of users 1710 or 1712, the first users may view the selected service providers of user 1710 or 1712.

An example of the display of the service provider record may be found in FIG. 9. Service provider record 908 of FIG. 9 shows a review associated with a real estate listing. Service provider record includes a thumbnail image of the real estate listing associated with the service provider record, a map of the geographic location of the real estate listing, other information regarding the real estate listing and the real estate broker's review or insight review of the real estate listing.

In the presented embodiments, the service provider records are reviews of real estate listing. It can be appreciated that the service provider records are reviews of other objects such as jobs completed by carpenters, plumbers and other craftsmen, or images from a photographer's portfolio, or hair styles by a particular hairdresser, etc.

In some embodiments, a user interact may with the map of FIG. 5 to search for a service provider associated with a particular service provider record. Map module 222 of service provider record system may provide the map 500 of FIG. 5. In one example, the user provides one or more filter criteria, and sends a request to service provider record system 106 to search for home renovation projects found within 5 miles of the user's home address. In response to the user's request map module 222 sends a request to service provider record datastore 212. Service provider record datastore 212 receives the request and filter the service provider records according to the received request, and requested sends the service provider records, along with projects associated with the requested service provider records which fit the user's request to map module 222. Map module 222 receives the requested service provider records and associated projected associated with the requested service provider records and updates the map 500 with project icons representing the geographic location of the projects associated with the requested service provider records. The user may mouse over, or move a cursor over, one of the project icon to obtain a preview of the project with additional information such as the address of the home renovation and a thumbnail image showing some of the renovations that was completed. The user may select the project icon to receive further information regarding the home renovation project. The map module 222 interprets the user's selection, and map module 222 may send a request to service provider record datastore 212 for the user's selected home renovation project associated with the user's selection. Service provider record datastore 212 receives the request of the user's selection from map module 222 and provides a project page with additional information regarding the project. The project page can include images, videos, etc. of the home renovation project which was completed, information regarding a general contractor responsible for the home renovation project, and service provider records associated with the home renovation project. Information regarding the general contractor responsible for the home renovation project may include contact information, hyperlink to the general contractor's profile page, hyperlink to add the general contractor to the user's service provider network. The user may send a request to map module 222 for the general contractor's profile page to service provider record datastore 212. Service provider record datastore 212 may receive the user's request for the general contractor's profile page and provides the general contractor's profile page to the user.

The user may navigate the general contractor's profile page to obtain additional information regarding the general contractor, including service provider records of the general contractor provided by users, projects that the general contractor completed displayed on a map, and users or service providers who are on the general contractor's network of selected service providers, such as his selected painters, or electricians. For each of the service providers on the network of selected service providers, information such as the name, an image of the service provider, a hyperlink to direct the user to the selected service provider's profile page and a hyperlink to add the selected service provider to the user's service provider network is displayed. The user may select the hyperlink to the selected painter's profile page and map module 222 may send a request for the painter's profile page to service provider record datastore 212. Service provider record datastore 212 may receive the user's request for the painter's profile page and provides the painter's profile page to the user.

The user may navigate the painter's profile page to obtain additional information regarding the painter, including service provider records of the painter provided by users, projects that the painter completed displayed on a map, and users or service providers who are on the painter's network of selected service providers. It is in this way that the user may navigate from the map to a particular project, to the general contractor to the painter, etc. and view the projects completed by each service provider, and service provider records of each of the service providers left by other users and the like.

FIG. 11 depicts the project page 1100 of a real estate listing. Project page 1100 includes detailed information regarding the real estate listing 1108, images 1102 and 1104, information regarding the listing real estate broker, or user who submitted the project page 1106 and ways to share the project page.

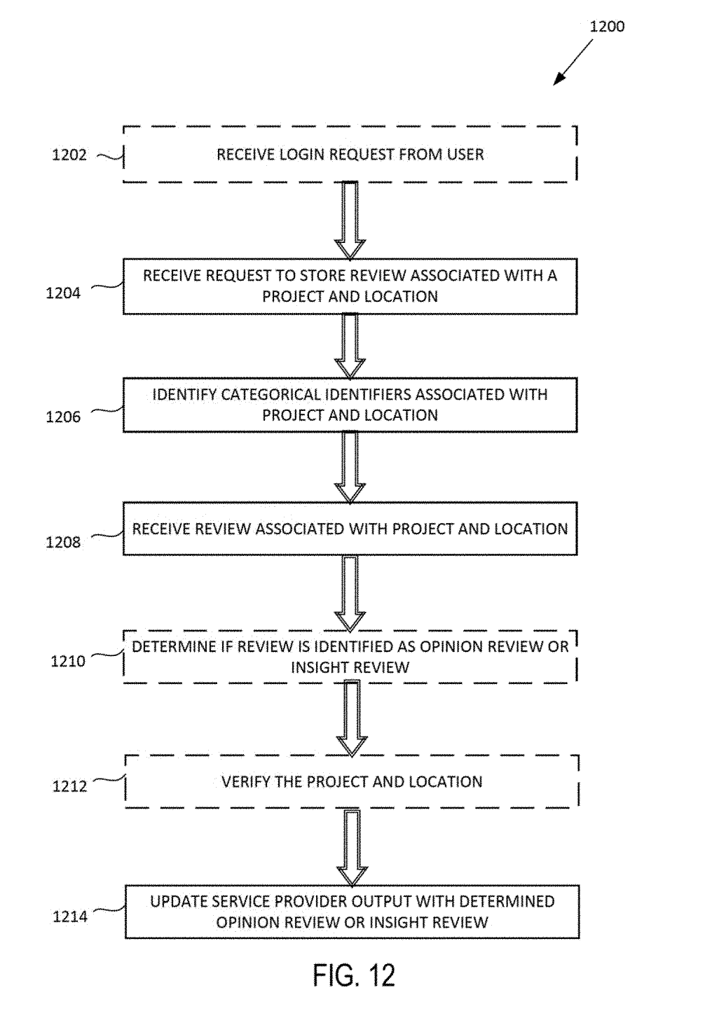

FIG. 12 depicts a flow chart 1200 of a method of submission of a service provider records according to some embodiments. In option step 1202, the authentication module 204 may authenticate a user's login and password. The login and password may be associated with the user's account. In some embodiments, the authentication module 204 may, after authentication, determine data permissions prior to allowing users to store to content within the content delivery system datastore 216. In various embodiments, the service provider record system 106 only needs to authenticate a user if the user wants to store a review associated with a project and location to the service provider record datastore 212.

In step 1204, the search module 206 receives a request to store a review or service provider record associated with a project and geographic location. In some embodiments, the user may send a request to store a review or service provider record associated with the project and geographic location from map 1000 of FIG. 10. The user may obtain the preview of a project associated with the service provider record. The user may click on or in the preview of the project 1002, in this case, a real estate listing, and leave a service provider record or a review of the real estate listing.

In step 1206, search module 206 identifies the categorical identifiers associated with the project and location, which may include tags, time stamp of the service provider records, geographical location, the type of review, user identification and others. Search module 206 may output a review form to the output device of user system 102, including an area for the user to input a textual component of the review, an area for the user to input images and video and other digital media, and check boxes or fields for the user to enter tags, select the type of review, keywords, and others.

In step 1208, the search module receives the review form from user system 102 with the user's input to some of the sections of the form identified in step 1206.

In step 1210, the insight categorization module 220 may determine if a review submitted by a user can be categorized as an opinion review or an insight review. In some embodiments, the service provider record system 106 allows users to choose to categorize a review as an opinion review or an insight review when the review is submitted. In some embodiments, step 1210 is optional and may be omitted.

In step 1212, the authentication module 204 verifies that the project and location associated with the service provider record is real and is not falsified. In some embodiments, step 1212 is optional and may be omitted.

In step 1214, the service provider record output is updated, such as map 500 of FIG. 5 or map 1000 of FIG. 10 with the determined opinion review or insight review. A flag or icon may differentiate between an opinion review or an insight review.

In various embodiments, a project is a landmark, a place of business, such as a restaurant, a grocery store, a clothing shop, etc. A plurality of service provider records or reviews, may be associated with one project, however, one service provider record is associated with one project. In the presented embodiments, the service provider records are reviews of real estate listing. It can be appreciated that the service provider records are reviews of other objects such as projects completed by carpenters, plumbers and other craftsmen, or images from a photographer's portfolio, or hair styles by a particular hairdresser, etc.

U.S. Nonprovisional application Ser. No. 15/788,651, entitled “Collecting and Providing Customized User Generated Content Across Networks Based on Domain,” filed Oct. 19, 2017, is incorporated by reference herein.

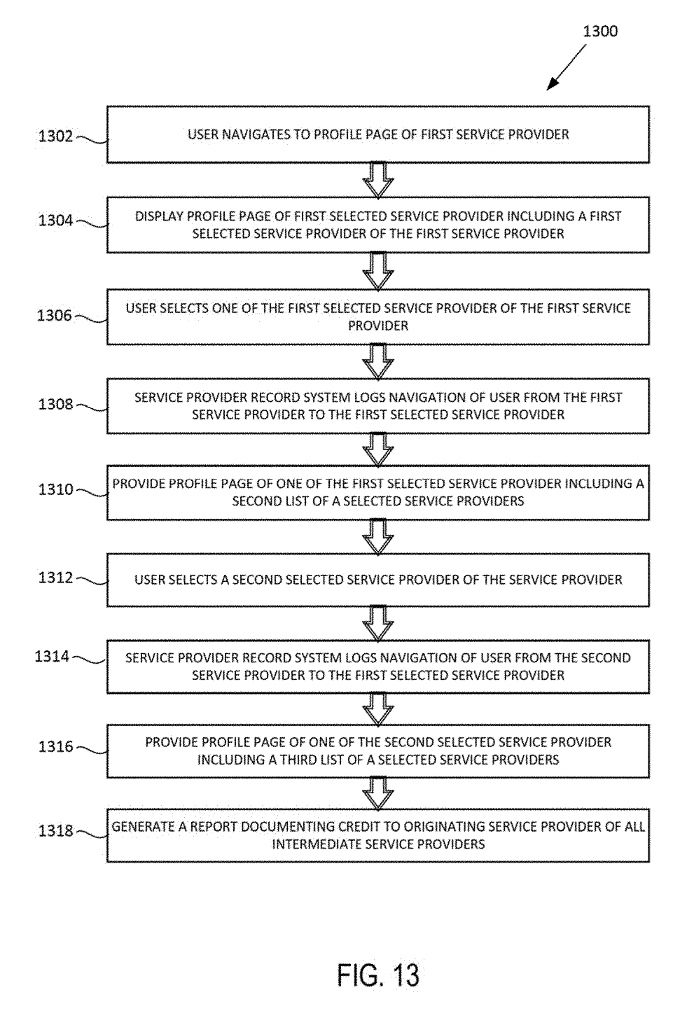

FIG. 13 depicts a flow chart 1300 of a method of a user navigating service providers according to some embodiments. In step 1302, the user navigates to a profile page of a first service provider, such as a real estate agent. This may be accomplished in a number of ways.

In another embodiment, the user may navigate to his/her own profile page, such as profile page 400 of FIG. 4 and select one of the user's selected service providers in area 402. The search module 206 may submit a request to the service provider record datastore 212 for the profile page of the first service provider.

In one example, the user may submit a search query comprising a plurality of search criteria, such as the search query 700 of FIG. 7, to the search module 206. The search module 206 may submit a request to a request to service provider record datastore 212 and return to the user the profile page of the first service provider. In various embodiments, the user may navigate to the profile page of the first service provider from the search result listing 800 of FIG. 4. The user may submit the search query comprising a plurality of search criteria, such as the search query 700 of FIG. 7 to the search module 206. The search module 206 may submit a request to a request to service provider record datastore 212 and return search result listing 800. Search result listing 800 includes a plurality of service providers which match the user's search query. The plurality of service providers in the search result listing 800 may be sorted in order of relevancy to the search query, or the listing may be sorted with respect to other factors. The user may select to one of the plurality of service providers and navigate to the profile page of the selected service provider.

In step 1304, the service provider record datastore 212 may receive the request from the search module 206 for the profile page of the first service provider and service provider record datastore 212 may provide the requested profile page to output device of user system 102. The profile page of the first service provider, such as the profile page 400 of FIG. 4 includes a first list of selected service provider, such as the selected service providers in area 402.

In step 1306, the user selects one of the first selected service provider, such as a plumber, of the first service provider by interacting with one of the first list of selected service providers listed in area 402. A request for the profile page of one of the first list of selected service provider to the search module 206. The search module 206 may receive this request from user system 102 and send the request to service provider record datastore 212.

In step 1308, the navigational path module 224 tracks the navigational path from the first service provider to the one of the first list of selected service provider and generates a report documenting the navigational path to and from each service provider or user in service provider record system 106. The report may be sent periodically to each service provider or user in service provider record system 106.

In step 1310, the service provider record datastore 212 may receive the request from search module 206 and provide the profile page of the one of the first list of selected service provider and service provider record datastore 212 may provide the requested profile page of the first list of selected service provider to output device of user system 102. The profile page of the first selected service provider includes a second list of selected service provider.

In step 1312, the user selects one of the second list of selected service provider, such as a photographer, of the first service provider by interacting with one of the second list of selected service providers listed in area 402. A request for the profile page of one of the second selected service provider to search module 206. The search module 206 may receive this request from user system 102 and send the request to service provider record datastore 212.

In step 1314, the navigational path module 224 tracks the navigational path from the one of the first list of selected service provider (plumber) to the one of the second list of selected service provider (photographer) and entries in the navigational path module 224 may generate a report documenting the navigational path to and from each service provider or user in service provider record system 106.

In step 1316, the service provider record datastore 212 may receive the request from search module 206 and provide the profile page of one of the second list of selected service provider and service provider record datastore 212 may provide the requested profile page of one of the second list of selected service provider to output device of user system 102. The profile page of one of the second selected service provider includes a third list of selected service provider.

In step 1318, the navigational path module 224 generates a report documenting navigational path to and from each service provider or user in service provider record system 106. The report may be sent periodically to each service provider or user in service provider record system 106.

It can be appreciated that users of service provider record system 106 can be service, and users can be service providers. The term “users” and “service providers” can be used interchangeably.

In the present disclosure, service provider's network comprises selected service providers. In some embodiments, service provider's network comprises users.

FIG. 15 depicts a block diagram of an example computing device 1502 according to some embodiments. Any user system 102, service provider record system 106 and domain system 108 may comprise an instance of computing device 1502. Computing device 1502 comprises a processor 1504, a memory 1506, a storage 1508, an input device 1510, a communication network interface 1512 and an output device 1514. Processor 1504 is configured to execute executable instructions (e.g., programs). In some embodiments, the processor 1804 comprises circuitry or any processor capable of processing the executable instructions.

Memory 1506 stores data. Some examples of memory 1506 include storage devices, such as RAM, ROM, RAM cache, virtual memory, etc. In various embodiments, working data is stored within memory 1506. The data within memory 1506 may be cleared or ultimately transferred to storage 1508.

Storage 1508 includes any storage configured to retrieve and store data. Some examples of storage 1508 includes flash drives, hard drives, optical drives, and/or magnetic tape. Each of memory system 1506 and storage system 1508 comprises a computer-readable medium, which stores instructions or programs executable by processor 1504.

Input device 1510 is any device that inputs data (e.g., mouse, keyboard, stylus). Output device 1514 outputs data (e.g., speaker, display, virtual reality headset). It will be appreciated that storage 1508, input device 1510 and output device 1514 may be optional. For example, routers/switchers may comprise processor 1504 and memory 1506 as well as a device to receive and output data (e.g., communication network interface 1512 and/or output device 1514).

Communication network interface 1512 may be coupled to a network (e.g. communication network 104) via communication network interface 1512. Communication network interface 1512 may support communication over an Ethernet connection, a serial connection, a parallel connection, and/or an ATA connection. Communication network interface 1512 may also support wireless communication (e.g., 802.11 a/b/g/n, WiMax, LTE, WiFi). It will be apparent that communication network interface 1512 may support many wired and wireless standards.

The output device 1514 outputs data (e.g., speaker, display, virtual reality headset). It will be appreciated that the storage 1508, input device 1510 and output device 1514 may be optional. For example, routers/switchers may comprise processor 1504 and memory 1506 as well as a device to receive and output data (e.g., communication network interface 1512 and/or output device 1514).

An engine may be hardware or software. In some embodiments, the engine may configure one or more processors to perform functions associated with the engine. Although different engines are discussed herein, it will be appreciated that the server system 106 may include any number of engine performing any or all functionality discussed herein.

1. A non-transitory computer readable medium comprising instructions executable by a processor, the instructions being executable to perform a method, the method comprising:
registering, by a service provider record system, accounts for a plurality of users;
authenticating, by the service provider record system, a first user of the plurality of users;
receiving a first request to store a first service provider record, the first service provider record by the first user of the plurality of users, the first service provider record being associated with a first project located at a first geographic location, the first request to store service provider record including a first user identifier, one or more first categorical identifiers associated with the first project indicating at least some work performed on the project, and a location identifier associated with the first geographic location, the first project associated with the first service provider record;
receiving a request from a first user device for project identifiers located within a section of a geographic area;
retrieving a first set of one or more project identifiers based on the request for the project identifiers located within the section of the geographic area;
providing the first set of the one or more project identifiers to the first user device, the first set of the one or more project identifiers to be displayed on a first map to the first user device, each particular project identifier of the first set of the one or more project identifiers to be displayed on the first map in a general location where work was performed on the particular project identifier;
receiving a request from a first user device for a subset of a first set of project identifiers located within a subsection of the geographic area;
retrieving the subset of the first set of project identifiers located within a subsection of the geographic area based on the request for the subset of the first set of project identifiers located within the subsection of the geographic area;
providing the subset of the first set of the one or more project identifiers to the first user device, the subset of the first set of the one or more project identifiers to be displayed on a second map the first user device, each particular project identifier of the subset of the first set of the one or more project identifiers to be displayed on the second map in a general location where work was performed on the particular project identifier;
receiving, from the first user device, a selected project of the subset of the first set of the one or more project identifiers, the selected project being the first project;
providing to the first user device, based at least in part on the first service provider record, a project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project;
receiving, from the first user device, a selection of the link to the at least one service professional's profile page associated with the selected project, the at least one service professional having performed work on the selected project; and
providing, to the first user device, a profile page of the at least one service professional, the profile page including contact information of the at least one service professional.

2. The non-transitory computer readable medium of claim 1, the method further comprising providing the first map and the second map.

3. The non-transitory computer readable medium of claim 1, the method further comprising receiving the insight review from the second reviewer, verifying that the second reviewer is a licensed professional, verifying that a license of the licensed professional is associated with the field associated with the at least some work performed on the selected project, and labelling the insight review as being an expert opinion.

4. The non-transitory computer readable medium of claim 1, the method further comprising receiving the opinion review from the first reviewer, verifying that the first reviewer is not a licensed professional, and labelling the opinion review as being a non-expert opinion.

5. The non-transitory computer readable medium of claim 1, the profile page of the at least one service professional including contact information.

6. The non-transitory computer readable medium of claim 1, the profile page of the at least one service professional including selected service professionals of the at least one service professional.

7. The non-transitory computer readable medium of claim 6, the method further comprising tracking navigation information of the user from the project page, to the profile page of the at least one service professional, and to a profile page of one of the selected service professionals linked to the profile page, and generating a report indicating at least some of the tracking navigation information to enable origination credit to the at least one service professional.

8. The non-transitory computer readable medium of claim 1, wherein retrieving the first set of one or more project identifiers based on the request for the project identifiers located within the section of the geographic area comprises determining a domain of a web page that provided the request for the project identifiers located within the section of the geographic area and retrieving the first set of one or more project identifiers based, at least in part, on the domain.

9. The non-transitory computer readable medium of claim 1, the method further comprising:
receiving a request from a second user device for project identifiers located within the section of a geographic area;
retrieving a second set of one or more project identifiers based on the request from the second user device for the project identifiers located within the section of the geographic area;
providing the second set of the one or more project identifiers to the second user device, the first set of the one or more project identifiers to be displayed on a second map to the second user device, each particular project identifier of the second set of the one or more project identifiers to be displayed on the second map in a general location where work was performed on the particular project identifier;
receiving a request from the second user device for a subset of a second set of project identifiers located within the subsection of the geographic area;
retrieving the subset of the second set of project identifiers located within the subsection of the geographic area based on the request for the subset of the second set of project identifiers located within the subsection of the geographic area;
providing the subset of the second set of the one or more project identifiers to the second user device, the subset of the second set of the one or more project identifiers to be displayed on a fourth map the second user device, each particular project identifier of the subset of the second set of the one or more project identifiers to be displayed on the fourth map in a general location where work was performed on the particular project identifier;
receiving, from the second user device, a selected project of the subset of the second set of the one or more project identifiers, the selected project being the first project;
providing to the second user device, based at least in part on the first service provider record, the project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project;
receiving, from the second user device, a selection of the link to the at least one service professional's profile page associated with the selected project, the at least one service professional having performed work on the selected project; and
providing, to the second user device, a profile page of the at least one service professional, the profile page including contact information of the at least one service professional.

10. A system comprising:
one or more processors; and
memory containing executable instructions, the executable instructions being executable by the one or more processors to perform a method, the method comprising:
registering, by a service provider record system, accounts for a plurality of users;
authenticating, by the service provider record system, a first user of the plurality of users;
receiving a first request to store a first service provider record, the first service provider record by the first user of the plurality of users, the first service provider record being associated with a first project located at a first geographic location, the first request to store service provider record including a first user identifier, one or more first categorical identifiers associated with the first project indicating at least some work performed on the project, and a location identifier associated with the first geographic location, the first project associated with the first service provider record;
receiving a request from a first user device for project identifiers located within a section of a geographic area;
retrieving a first set of one or more project identifiers based on the request for the project identifiers located within the section of the geographic area;
providing the first set of the one or more project identifiers to the first user device, the first set of the one or more project identifiers to be displayed on a first map to the first user device, each particular project identifier of the first set of the one or more project identifiers to be displayed on the first map in a general location where work was performed on the particular project identifier;
receiving a request from a first user device for a subset of a first set of project identifiers located within a subsection of the geographic area;
retrieving the subset of the first set of project identifiers located within a subsection of the geographic area based on the request for the subset of the first set of project identifiers located within the subsection of the geographic area;
providing the subset of the first set of the one or more project identifiers to the first user device, the subset of the first set of the one or more project identifiers to be displayed on a second map the first user device, each particular project identifier of the subset of the first set of the one or more project identifiers to be displayed on the second map in a general location where work was performed on the particular project identifier;
receiving, from the first user device, a selected project of the subset of the first set of the one or more project identifiers, the selected project being the first project;
providing to the first user device, based at least in part on the first service provider record, a project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project;
receiving, from the first user device, a selection of the link to the at least one service professional's profile page associated with the selected project, the at least one service professional having performed work on the selected project; and
providing, to the first user device, a profile page of the at least one service professional, the profile page including contact information of the at least one service professional.

11. The system of claim 10, the method further comprising providing the first map and the second map.

12. The system of claim 10, the method further comprising receiving the insight review from the second reviewer, verifying that the second reviewer is a licensed professional, verifying that a license of the licensed professional is associated with the field associated with the at least some work performed on the selected project, and labelling the insight review as being an expert opinion.

13. The system of claim 10, the method further comprising receiving the opinion review from the first reviewer, verifying that the first reviewer is not a licensed professional, and labelling the opinion review as being a non-expert opinion.

14. The system of claim 10, the profile page of the at least one service professional including contact information.

15. The system of claim 10, the profile page of the at least one service professional including selected service professionals of the at least one service professional.

16. The system of claim 15, the method further comprising tracking navigation information of the user from the project page, to the profile page of the at least one service professional, and to a profile page of one of the selected service professionals linked to the profile page, and generating a report indicating at least some of the tracking navigation information to enable origination credit to the at least one service professional.

17. The system of claim 10, wherein retrieving the first set of one or more project identifiers based on the request for the project identifiers located within the section of the geographic area comprises determining a domain of a web page that provided the request for the project identifiers located within the section of the geographic area and retrieving the first set of one or more project identifiers based, at least in part, on the domain.

18. The system of claim 10, the method further comprising:
receiving a request from a second user device for project identifiers located within the section of a geographic area;
retrieving a second set of one or more project identifiers based on the request from the second user device for the project identifiers located within the section of the geographic area;
providing the second set of the one or more project identifiers to the second user device, the first set of the one or more project identifiers to be displayed on a second map to the second user device, each particular project identifier of the second set of the one or more project identifiers to be displayed on the second map in a general location where work was performed on the particular project identifier;
receiving a request from the second user device for a subset of a second set of project identifiers located within the subsection of the geographic area;
retrieving the subset of the second set of project identifiers located within the subsection of the geographic area based on the request for the subset of the second set of project identifiers located within the subsection of the geographic area;
providing the subset of the second set of the one or more project identifiers to the second user device, the subset of the second set of the one or more project identifiers to be displayed on a fourth map the second user device, each particular project identifier of the subset of the second set of the one or more project identifiers to be displayed on the fourth map in a general location where work was performed on the particular project identifier;
receiving, from the second user device, a selected project of the subset of the second set of the one or more project identifiers, the selected project being the first project;
providing to the second user device, based at least in part on the first service provider record, the project page indicating the one or more first categorical identifiers associated with the first project indicating at least some work performed on the selected project and a link to at least one service professional's profile page associated with the selected project, the project page including at least one opinion review from a first reviewer and at least one insight opinion from a second reviewer, the second reviewer being a professional in a field associated with the at least some work performed on the selected project;
receiving, from the second user device, a selection of the link to the at least one service professional's profile page associated with the selected project, the at least one service professional having performed work on the selected project; and
providing, to the second user device, a profile page of the at least one service professional, the profile page including contact information of the at least one service professional.
